(19) United States
(12) Patent Application Publication
(10) Pub. No.: US 2025/0077774 A1
(43) Pub. Date: Mar. 6, 2025

(54) METHOD AND SYSTEM OF DOTTIZATION OF ARABIC TEXT RASMS

(71) Applicants: KING FAHD UNIVERSITY OF PETROLEUM AND MINERALS, Dhahran (SA); Saudi Data and Artificial Intelligence Authority (SDAIA), Riyadh (SA)

(72) Inventors: Irfan AHMAD, Dhahran (SA); Zainab Hathloul ALHATHLOUL, Riyadh (SA)

(73) Assignees: KING FAHD UNIVERSITY OF PETROLEUM AND MINERALS, Dhahran (SA); Saudi Data and Artificial Intelligence Authority (SDAIA), Riyadh (SA)

(21) Appl. No.: 18/429,700

(22) Filed: Feb. 1, 2024

Related U.S. Application Data
(60) Provisional application No. 63/580,000, filed on Sep. 1, 2023.

(51) Int. Cl. G06F 40/284; G06N 3/0442

(52) U.S. Cl. CPC G06F 40/284; G06N 3/0442

(57) ABSTRACT

A method and a system for dottization of an Arabic Rasm utilizes natural language processing to add dots to Arabic Rasm. Initially, an input sequence of Arabic Rasms i.e., Arabic words without dots, is converted into a machine-readable input sequence. Further, components such as URLs, symbols, punctuation marks, white spaces, diacritics, and Kashida characters are removed, producing a normalized sequence. This sequence is then further refined by consolidating characters that appear in varied forms into single form of character. The consolidated sequence undergoes tokenization, generating multiple tokens. Each token is then padded at both its ends and fed into a trained recurrent neural network for processing, generating Arabic Rasms with dots. The output sequence from the network are the Arabic words with dots (Arabic word representing the Arabic Rasm with their respective dots), the output sequence is also mapped to input sequence as training set.

### CROSS-REFERENCE TO RELATED APPLICATIONS

The present application claims benefit of priority to U.S. Provisional Application No. 63/580,000, filed Sep. 1, 2023, entitled “Automatic Addition of Dots to Arabic Text Rasms,” which is incorporated herein by reference in its entirety.

### STATEMENT OF PRIOR DISCLOSURE BY AN INVENTOR

Aspects of the present application were described in “Automatic dottization of Arabic text (Rasms) using deep recurrent neural networks,” Zainab Alhathloul, Irfan Ahmad, Pattern Recognition Letters, Volume 162, Pages 47-55, which is incorporated herein by reference in its entirety.

### STATEMENT OF ACKNOWLEDGEMENT

Support provided by Saudi Data and Artificial Intelligence Authority and King Fahd University of Petroleum and Minerals Joint Research Center for Artificial Intelligence (JRC-AI), Dhahran, Saudi Arabia, through funding project #JRC-AI-RFP-06 is gratefully acknowledged.

### BACKGROUND OF THE INVENTION

### Technical Field

The present disclosure relates generally to natural language processing and computational linguistics. More specifically, the present disclosure relates to a method and a system of adding dots to Arabic Rasms for enhanced readability.

### Description of Related Art

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

Arabic script is one of the most widely used writing systems in the world. The Arabic script is not just confined to the Arabic language but extends its influence on multiple languages across Asia and Africa. As may be appreciated, languages and scripts evolve over time. In the early stages of the Arabic language, the alphabet characters were represented only using shapes, called Rasm. These shapes did not include dots or diacritics. Some of the alphabet characters were represented with similar shapes. To differentiate between similar looking characters, dots were added to the characters. Subsequently, the diacritics were invented and are used for resolving ambiguities and for phonetic guidance. Nowadays, dots are used permanently with characters, unlike diacritics which are used in limited circumstances. FIGS. 1A-1C illustrate this idea with an example Arabic sentence written using only Rasms (as represented by reference numeral 100A in FIG. 1A), with the addition of dots (as represented by reference numeral 100B in FIG. 1B), and with the addition of diacritics along with dots (as represented by reference numeral 100C in FIG. 1C). It may be understood that Rasm (and thus, hereinafter, sometimes, interchangeably referred to as “Rasm” without any limitations) is essentially the skeletal version of the script, devoid of diacritics and dots which differentiate visually similar letters.

In several traditional manuscripts and certain calligraphic renditions, the original form of writing prevails, i.e., use of only shapes without dots and diacritics for Arabic alphabets still exists. For example, FIG. 2 depicts an image of a parchment (as represented by reference numeral 200) having an ancient Quranic manuscript written on it. As may be seen, it was written using Rasms and does not contain any dots.

A Rasm sequence without dots can represent several possible words. FIG. 3 presents two example Rasm sequences and different possible Arabic words they can represent (as represented by reference numeral 300). For the first sequence (the top row in the figure), there are six possible words the first Rasm sequence can represent, as shown, which have completely different meanings. Similarly, for the second sequence, the presented Rasm sequence can represent five different words with different meanings. The correct word depends on the context of the text, and it is difficult to identify instantly, even by a native speaker.

In recent years, the global digital landscape has witnessed a surging interest in the domain of natural language processing (NLP). This interest arises from the desire to bridge the gap between human languages and machine interpretation. Given the digital evolution and the increasing need for machine readability, the conversion of Rasm to its fully dotted version, ensuring diacritical accuracy and machine readability, has become imperative. However, the challenges associated with processing the Arabic Rasm are multifaceted. At its core, a Rasm presents a skeletal representation, often leaving out crucial diacritical marks and dots. This omission, while not problematic in specific cultural or traditional contexts, becomes a significant hurdle in digital processing where precise character recognition is paramount. Furthermore, the inherent nature of the Arabic script, where characters can assume different forms based on their position within a word (initial, medial, or final), increases the complexity. Added to this are the nuances introduced by the likes of Kashida characters, diverse forms of characters, and other intricacies. These challenges are not merely academic; they have real-world implications. For instance, in digitizing historical manuscripts, misinterpretation of Rasm can lead to loss of information or misrepresentation of original texts. Similarly, for online content in Arabic, improper processing of Rasm can hinder searchability, accessibility, and overall user experience. The implications in digital processing of Arabic texts could be problematic in the tokenization of Arabic texts for other natural language processing (NLP) tasks. Moreover, this has other implications, like in the field of social media moderation, where users use Arabic texts without dots to evade censorship. As an example, FIG. 4 shows an Arabic tweet using only Rasms (as represented by reference numeral 400). The translated tweet can have numerous interpretations based on the chosen meaning of a Rasm by the translator.

Many studies have been performed to automate the diacritization process, such as, Abandah et al. [G. A. Abandah, A. Graves, B. Al-Shagoor, A. Arabiyat, F. Jamour, M. Al-Taee, Automatic diacritization of Arabic text using recurrent neural networks, Int. J. Doc. Anal. Recognit. (IJDAR) 18 (2) (2015) 183-197], Metwally et al. [A. S. Metwally, M. A. Rashwan, A. F. Atiya, A multi-layered approach for Arabic text diacritization, in: 2016 IEEE International Conference on Cloud Computing and Big Data Analysis (ICCCBDA), IEEE, 2016, pp. 389-393], and Masmoudi et al. [A. Masmoudi, M. E. Khmekhem, L. H. Belguith, Automatic diacritization of Tunisian dialect text using recurrent neural network, in: Proceedings of the International Conference on Recent Advances in Natural Language Processing (RANLP 2019), INCOMA Ltd., Varna, Bulgaria, 2019, pp. 730-739]. Arabic diacritization is beneficial to other tasks in Arabic natural language processing (ANLP), such as translation as shown in Diab et al. [M. Diab, M. Ghoneim, N. Habash, Arabic diacritization in the context of statistical machine translation, in: Proceedings of Machine Translation Summit XI: Papers, Copenhagen, Denmark, 2007], Elshafei et al. [M. Elshafei, H. Al-Muhtaseb, M. Alghamdi, Statistical methods for automatic diacritization of Arabic text, in: The Saudi 18th National Computer Conference. Riyadh, vol. 18, 2006, pp. 301-306; incorporated herein by reference] formulated the diacritization problem using hidden Markov models (HMMs), wherein the hidden state sequence represents the diacritized character sequence and the observation sequence represents the plain character sequence without diacritics. Finding the optimal state sequence given the observation sequence is performed using the Viterbi algorithm. All the needed probabilities were computed using the statistics of the training data. A dictionary mapping words to different diacritized versions of the words is consulted during decoding.

Recent works have presented deep learning systems for the diacritization process by investigating different neural network types and architectures. Automatic diacritization using a deep bidirectional long short-term memory (BLSTM) architecture is known. For example, a system that uses undiacritized characters as input and predicts the characters and their diacritics at every time step using a SoftMax layer that provides a probability distribution over the possible character diacritics combination. Letter correction can be performed as postprocessing if the system outputs a different character instead of the input character. Furthermore, sukun diacritic can be excluded from evaluation. A dictionary can be consulted to ensure that the diacritized version is among the forms seen in the training data for a given word. The presence of errors on the last character of words may be a main source of the problem. A similar approach was presented [Y. Belinkov, J. Glass, Arabic diacritization with recurrent neural networks, in: Proceedings of the 2015 Conference on Empirical Methods in Natural Language Processing, 2015, pp. 2281-2285] using stacked BLSTMs for the task. Precomputed word2vec embeddings were used in addition to learned embeddings without observing any significant difference in the results [see also G. Abandah, A. Abdel-Karim, Accurate and fast recurrent neural network solution for the automatic diacritization of Arabic text, Jordanian J. Comput. Inf. Technol. 6 (2) (2020) 103-121]. Different output encoding schemes and different network architectures have been investigated, including unidirectional and bidirectional LSTMs and encoder-decoder architecture, with BLSTMs performing the best. Regarding the output encoding, different schemes were attempted such as predicting the character with the diacritics or predicting only the diacritics given the input characters. The latter approach leads to a significantly smaller SoftMax layer compared to the other approaches and shows the best performance.

Arabic diacritization task was formulated as neural machine translation employing an encoder-decoder deep learning architecture to solve the problem [H. Mubarak, A. Abdelali, H. Sajjad, Y. Samih, K. Darwish, Highly effective Arabic diacritization using sequence to sequence modeling, in: Proceedings of the 2019 Conference of the North American Chapter of the Association for Computational Linguistics: Human Language Technologies, Volume 1 (Long and Short Papers), 2019, pp. 2390-2395]. Characters are used as input tokens in addition to a special symbol for word boundaries. The output is the corresponding character along with the diacritics associated with it as sub-word units. Using characters as input tokens helps deal with out-of-vocabulary (OOV) issues. In order to deal with long-range dependencies, a sliding window approach was used where an input sentence is split into multiple smaller sentences based on the window width. The window is shifted one word at a time, and thus, a word in a sentence will appear in multiple samples. In the prediction time, majority voting is employed over different outputs for the same word to decide the final diacritic sequence for the word. LSTMs with attention mechanism as well as transformer models were explored. Both systems showed similar performance and combining the output from both systems led to a small improvement over the best results.

A comparative study was presented by empirically evaluating some of the publicly available diacritization tools [O. Hamed, T. Zesch, A survey and comparative study of Arabic diacritization tools, J. Lang. Technol. Comput. Linguist. 32 (1) (2017) 27-47]. The problem of diacritizing inflectional case endings that typically are at the last character of the word was discussed. Another comparative work evaluating different diacritization algorithms was presented [A. Fadel, I. Tuffaha, M. Al-Ayyoub, et al., Arabic text diacritization using deep neural networks, 2nd International Conference on Computer Applications & Information Security (ICCAIS), IEEE, 2019, pp. 1-7]. A number of statistical approaches with a neural network-based system that uses BLSTM along with character embeddings for Arabic text diacritization was evaluated. The BLSTM system outperforms other systems. An informative survey on Arabic diacritization was presented [A. M. Azmi, R. S. Almajed, A survey of automatic Arabic diacritization techniques, Nat. Lang. Eng. 21 (3) (2015) 47]. The survey mainly covers rule-based and statistical approaches. A recent survey on the topic was presented [M. M. Almanea, Automatic methods, and neural networks in Arabic texts diacritization: a comprehensive survey, IEEE Access 9 (2021) 145012-145032], where the different techniques for automatic diacritization of Arabic text was comprehensively presented, including deep learning systems. It was concluded that BLSTMs are the most effective for the diacritization task in terms of accuracy.

It is important to note here that Arabic text diacritization has similar counterparts in other Semitic languages such as Hebrew. Both Arabic and Hebrew characters are Abjads, where characters are consonants. It is important to note here that dots in Arabic are not diacritics but are part of the characters, whereas Hebrew script uses dots in their diacritics system. A hybrid rule-based deep learning approach for Hebrew text diacritization was presented [A. Shmidman, S. Shmidman, M. Koppel, Y. Goldberg, Nakdan: professional Hebrew diacritizer, in: Proceedings of the 58th Annual Meeting of the Association for Computational Linguistics: System Demonstrations, Association for Computational Linguistics, Online, 2020, pp. 197-203]. A POS tagging and morphological disambiguation of the input word sequence using BLSTM transducers was performed. The prediction of the tagging system is constrained using a lexicon that maps word form to morphological analysis. All possible tags are allowed for words not available in the lexicon. A set of possible diacritics for a word is filtered by matching its morphological analyses with the predicted analysis for the word. Again, words not in the list are not constrained in terms of diacritization. As a last step, an LSTM-based system ranks the filtered diacritics for a given word obtained from the previous step by predicting the diacritics at the character level using beam search.

Further, many published studies show that recurrent neural networks (RNNs) achieve good results on different Arabic NLP tasks in addition to Arabic text diacritization. For example, a dialect classification using deep learning models was presented in a study [L. Lulu, A. Elnagar, Automatic Arabic dialect classification using deep learning models, Procedia Comput. Sci. 142 (2018) 262-269]. Different model configurations and network designs were investigated for the experiments, including the use of LSTMs and BLSTMs. An Arabic poem meter classification using stacked BLSTMs was presented [M. S. Al-shaibani, Z. Alyafeai, I. Ahmad, Meter classification of Arabic poems using deep bidirectional recurrent neural networks, Pattern Recognit. Lett. 136 (2020) 1-7]. The input to the system is a sequence of characters representing a verse of a poem, and the system classifies the poem meter of the verse.

Some researchers have investigated the idea of splitting the task of Arabic text recognition into multiple stages involving recognizing Arabic Rasms separately from dots and then combining the Rasms and dots to output the final Arabic texts [see I. Ahmad, G. A. Fink, Multi-stage HMM based Arabic text recognition with rescoring, in: 2015 13th International Conference on Document Analysis and Recognition (ICDAR), IEEE, 2015, pp. 751-755; and I. Ahmad, G. A. Fink, Handwritten Arabic text recognition using multi-stage sub-core-shape HMMs, Int. J. Doc. Anal. Recognit. (IJDAR) 22 (3) (2019) 329-349. However, none of the mentioned references teach automatically adding dots to Arabic Rasms.

Although automatic Arabic diacritization is a related problem to automatic Arabic dottization, they have differences at the same time. Dots are more fundamental in Arabic texts compared to the diacritics. Most Arabic texts are written without diacritics but not without dots. The challenges and opportunities involved in adding dots are different from those involved in adding diacritics. Although a character can take any diacritic from among the possible diacritics in Arabic, a sequence of diacritics over a word is very limited. Nouns, for example, have a fixed sequence of diacritics, and they do not change except the diacritic on the last character. Furthermore, the sequence of diacritics over a verb follows a certain template, such as fatha fatha fatha as in [symbol] or damma kasra fatha as in [symbol] and they cannot appear in every possible combination. Additionally, many of the diacritics can appear only at specific positions in a word. For example, the diacritic sukun cannot come over the first character of a word. Similarly, tanwin diacritics can only appear over the last character of a word. On the other hand, dots are fundamental in defining the characters themselves. They do not follow a fixed template as diacritics. Additionally, some Arabic Rasms belong to a single character (like I and J) and do not have dots. Moreover, some word Rasms lend themselves to only a specific word in Arabic, as no other Arabic word appears with the same Rasm sequence. Furthermore, homographs in Arabic can have different diacritics, but dottization does not face such issues. For example, the Arabic word [symbol] can mean the noun gold or the verb he went depending on the diacritic over the last character. On the other hand, many verb forms, such as (he writes) and (she writes) and (we write) have the same Rasm sequence but different dots in the prefix, but all the forms have the same diacritic sequence, fatha sukun damma fatha.

There has been no comprehensive solution proposed in the art for dottization of Arabic Rasm, addressing the aforementioned challenges. Traditional methods have often been directed towards rule-based systems. These systems utilize pre-defined rules and algorithms that dictate the conversion of Rasm to its dotted counterpart. Such rule-based systems consider the common patterns and structures within the Arabic script to facilitate the dottization process. However, such rule-based systems, despite their deterministic nature, often struggle with variations, nuances, or anomalies in real-world data. Their static nature meant that they lacked adaptability, making them less equipped to handle diverse forms of Arabic script encountered in different manuscripts or digital content. Another proposed approach has been the use of template matching. Here, the undotted characters in Rasm are matched against a repository of templates to identify the most likely dotted counterpart. However, template matching is constrained by the extent and diversity of the template repository. Any character form which may not be present in the repository could lead to mismatches or failed conversions.

Accordingly, it is one object of the present disclosure to provide a more robust, adaptable, and accurate solution for Arabic Rasm processing, converting Arabic Rasm into a fully dotted version without compromising on accuracy or efficiency. Since dots are more fundamental to the Arabic script (as being introduced before diacritics), the present disclosure provides techniques for automatic dottization of Arabic Rasm texts and contributes to Arabic text NLP (ANLP) research both directly and indirectly.

### SUMMARY OF THE INVENTION

In an exemplary embodiment, a method of dottization of an Arabic Rasm is provided. The method includes converting the Arabic Rasms to an input sequence of machine-readable symbols. The method further includes removing one or more components from the input sequence generating a normalized sequence. Herein, the one or more components include at least one of a URL, a symbol, a punctuation mark, a white space, a diacritic, and a Kashida character. The method further includes consolidating a set of characters appearing in diverse forms in the normalized sequence into a single form of character. The method further includes consolidating a set of characters appearing in diverse forms in the normalized sequence into a single form of character. The method further includes performing a tokenization on the consolidated sequence generating a plurality of tokens. The method further includes applying a padding to a first end and to a second end of each token of the plurality of tokens. The method further includes inputting the plurality of tokens to a recurrent neural network for processing. Herein, the recurrent neural network is trained by mapping between an input and an output of the recurrent neural network. The method further includes mapping an output sequence of the recurrent neural network to an Arabic word. Herein, the output sequence is the Arabic Rasm with dots. The method further includes mapping the output sequence to the Arabic Rasm for generating a training set for the recurrent neural network.

In some embodiments, each token of the plurality of tokens is a word sequence.

In some embodiments, each token of the plurality of tokens is a character sequence of an Arabic script.

In some embodiments, a character in the character sequence includes a character shape depending on a position of the character in the character sequence.

In some embodiments, the recurrent neural network is a bidirectional recurrent neural network.

In some embodiments, the processing by the recurrent neural network further includes converting the plurality of tokens to a plurality of dense vectors utilizing an embedding layer. Herein, the embedding layer includes a plurality of dense embeddings. The processing by the recurrent neural network further includes processing the plurality of dense vectors utilizing a consecutive set of gated recurrent units. Herein, the consecutive set of gated recurrent units mapping the input to the output for training the recurrent neural network. The processing by the recurrent neural network further includes performing a rectified linear unit activation on the processed output utilizing a fully connected dense layer. The processing by the recurrent neural network further includes reducing overfitting utilizing a dropout layer. The processing by the recurrent neural network further includes generating a SoftMax activation function through a dense layer.

In some embodiments, the method further includes determining a count of gated recurrent units in the consecutive set of gated recurrent units corresponding to a type of the plurality of tokens.

In some embodiments, the method further includes determining a count of units in the dense layer corresponding to a type of the plurality of tokens.

In some embodiments, a type of the plurality of tokens is at least one of a word token and a character token.

In some embodiments, the recurrent neural network employs a sequence-to-sequence learning approach.

In some embodiments, the method further includes selecting the Arabic Rasm from at least one of an Arabic manuscript, the Arabic Rasm obtained from a text image, and a digital Rasm sequence.

In another exemplary embodiment, a system for dottization of an Arabic Rasm is provided. The system includes a processing circuitry. The processing circuitry is configured to convert the Arabic Rasm to an input sequence of machine-readable symbols. The processing circuitry is further configured to remove one or more components from the input sequence to generate a normalized sequence. Herein, the one or more components include at least one of a URL, a symbol, a punctuation mark, a white space, a diacritic, and a Kashida character. The processing circuitry is further configured to consolidate a set of characters appearing in diverse forms in the normalized sequence into a single form of character. The processing circuitry is further configured to perform a tokenization on the consolidated sequence to generate a plurality of tokens. The processing circuitry is further configured to apply a padding to a first end and at a second end of each token of the plurality of tokens. The processing circuitry is further configured to input the plurality of tokens to a recurrent neural network for processing. Herein, a training of the recurrent neural network is achieved by mapping an input to an output. The processing circuitry is further configured to map an output sequence of the recurrent neural network to an Arabic word. Herein, the output sequence is the Arabic Rasm with dots. The processing circuitry is further configured to map the output sequence to the Arabic Rasm as a training set for the recurrent neural network.

In some embodiments, the plurality of tokens includes at least one of a word token and a character token.

In some embodiments, a character in the character token includes a character shape depending on a position of the character in the character token.

In some embodiments, the recurrent neural network is a bidirectional recurrent neural network.

In some embodiments, the processing circuitry is further configured to convert the plurality of tokens to a plurality of dense vectors utilizing an embedding layer. Herein, the embedding layer includes a plurality of dense embeddings. The processing circuitry is further configured to process the plurality of dense vectors utilizing a consecutive set of gated recurrent units. Herein, the consecutive set of gated recurrent units maps the input to the output for training the recurrent neural network. The processing circuitry is further configured to perform a rectified linear unit activation on the processed output utilizing a fully connected dense layer. The processing circuitry is further configured to reduce overfitting utilizing a dropout layer. The processing circuitry is further configured to generate a SoftMax activation function through a dense layer.

In some embodiments, a count of gated recurrent units in the consecutive set of gated recurrent units is corresponding to a type of the plurality of tokens.

In some embodiments, a count of units in the dense layer is corresponding to a type of the plurality of tokens.

In some embodiments, the Arabic Rasm is at least one of an Arabic manuscript, the Arabic Rasm obtained from a text image, and a digital Rasm sequence.

The foregoing general description of the illustrative embodiments and the following detailed description thereof are merely exemplary aspects of the teachings of this disclosure, and are not restrictive.

### BRIEF DESCRIPTION OF THE DRAWINGS

A more complete appreciation of this disclosure and many of the attendant advantages thereof will be readily obtained as the same becomes better understood by reference to the following detailed description when considered in connection with the accompanying drawings, wherein:

FIG. 1A is an exemplary sentence in Arabic script (translated in English as “I went to my uncle's house”) using only Rasms;

FIG. 1B is the exemplary sentence of FIG. 1A in Arabic script using dots with Rasms;

FIG. 1C is an exemplary sentence of FIG. 1A in Arabic script using diacritics in addition to dots;

FIG. 2 is an exemplary sample image from an early Quran manuscript (archived by the University of Birmingham Library) showing was it written using Rasms and does not contain any dots;

FIG. 3 presents two exemplary Rasm words and corresponding different possible Arabic words that can be represented with dots for each of the given two example Rasm words;

FIG. 4 is an exemplary text in Arabic script (posted as a “tweet”) using only Rasms;

FIG. 5A presents a list of characters in Arabic script;

FIG. 5B presents a list of Rasms used by the characters in the Arabic script;

FIG. 6 is a flowchart listing steps involved in a method of dottization of an Arabic Rasm, according to certain embodiments;

FIG. 7 is a schematic representation of an architecture implemented by a recurrent neural network for dottization of the Arabic Rasm, according to certain embodiments;

FIG. 8 is an illustration of a non-limiting example of details of computing hardware used in a processing circuitry of a system for dottization of an Arabic Rasm, according to certain embodiments;

FIG. 9 is an exemplary schematic diagram of a data processing system used within the processing circuitry, according to certain embodiments;

FIG. 10 is an exemplary schematic diagram of a processor used with the processing circuitry, according to certain embodiments; and

FIG. 11 is a graph plotting percentage of error characters based on their positions in the words, according to certain embodiments.

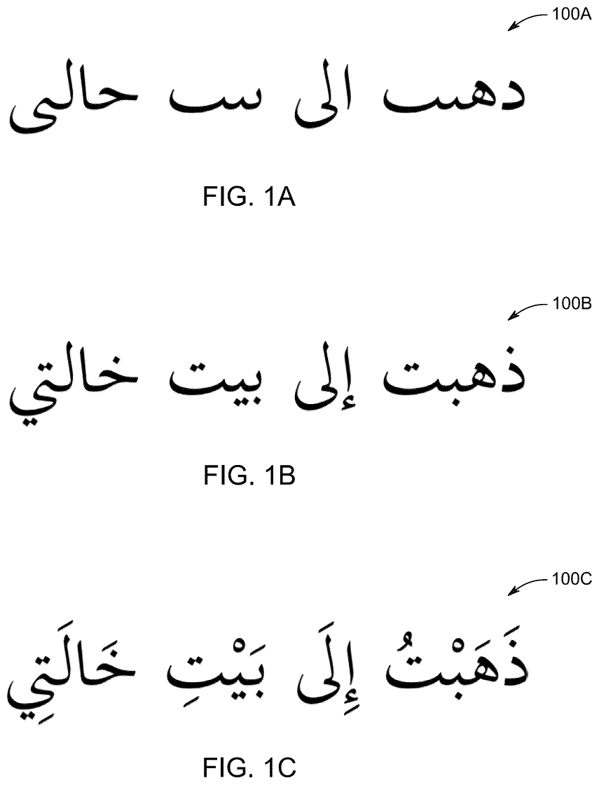

### DETAILED DESCRIPTION

In the drawings, like reference numerals designate identical or corresponding parts throughout the several views. Further, as used herein, the words “a,” “an” and the like generally carry a meaning of “one or more,” unless stated otherwise.

Furthermore, the terms “approximately,” “approximate,” “about,” and similar terms generally refer to ranges that include the identified value within a margin of 20%, 10%, or preferably 5%, and any values therebetween.

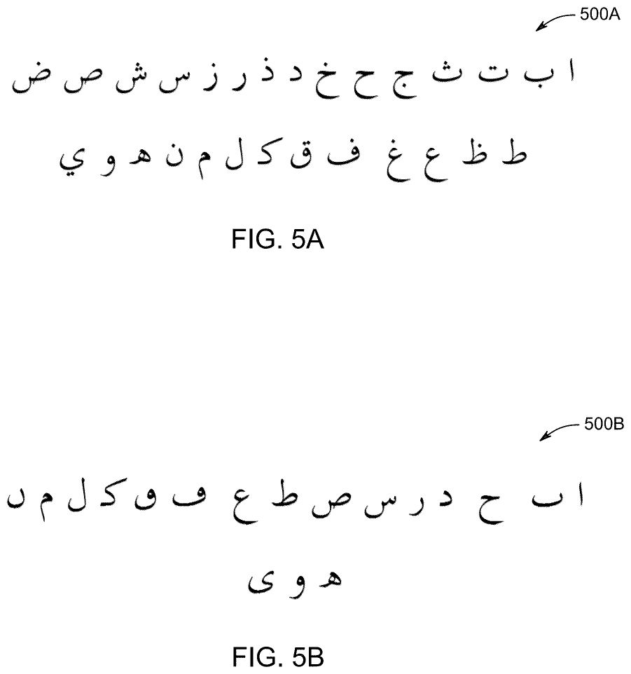

The writing system of Arabic script has certain rules, as most languages do. Arabic script is written from right to left, includes 28 characters, and the script does not have upper or lower cases as in English language. Some characters of Arabic script have no dots, while many of the characters have dots either above or below them. FIG. 5A presents a list of characters (as represented by reference numeral 500A) in Arabic script. FIG. 5B presents a list of Rasms (as represented by reference numeral 500B) used by the characters in the Arabic script. As shown in FIGS. 5A and 5B, there are 28 characters which use 18 unique Rasms. It may be seen that many characters share the same Rasm between them. For example, the three characters ( [symbol] ) are mapped to a single Rasm, as shown in FIGS. 5A and 5B. Furthermore, an Arabic character can have many shapes according to its positions in a word. Generally, characters can take four possible positions, including, at the beginning of the word, in the middle of the word, at the end of the word, and in addition, characters can take an isolated position if they do not connect to any character either before or after them. Moreover, some characters share the same position dependent Rasm as other characters. For example, the character ( [symbol] ) has the same shape at the beginning of the word as characters ( [symbol] ). Some characters share the same Rasm in the beginning and middle positions, whereas other characters share the same Rasm even in the ending and isolated positions.

Aspects of this disclosure are directed to techniques for processing and enhancing Arabic script. Specifically, the present disclosure focuses on the transformation of Arabic Rasm, a skeletal form of the script, into a machine-readable format by its dottization. Leveraging advanced machine learning techniques and neural network architectures, the present disclosure offers a robust and adaptable solution to address the unique challenges posed by the Arabic script in various digital applications.

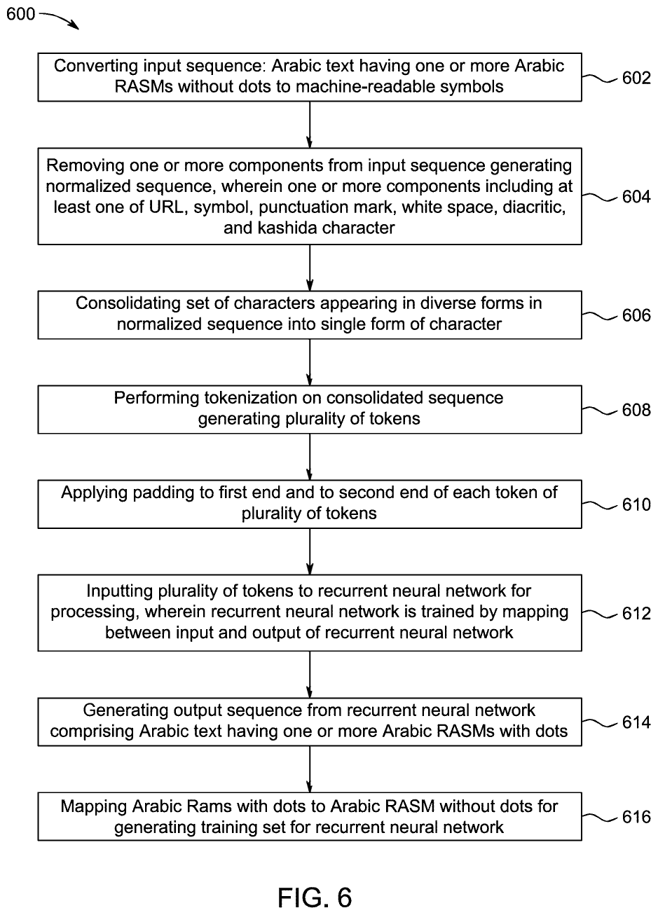

Referring to FIG. 6, illustrated is a flowchart listing steps involved in a method (as represented by reference numeral 600) of dottization of an Arabic Rasm. The method 600 involves converting the Arabic Rasms, i.e., Arabic word without dots into an input sequence of machine-readable symbols. This sequence is then normalized by removing various components, followed by the consolidation of diverse characters into a unified form. The sequence undergoes tokenization, and each token receives padding at its ends. These tokens are then processed through a recurrent neural network, which has been trained by mapping between its input and output. The output sequence, which is the dotted version of the Arabic Rasm, serves as an Arabic word. This output sequence can also be mapped back to the original Rasm, aiding in the training of the recurrent neural network.

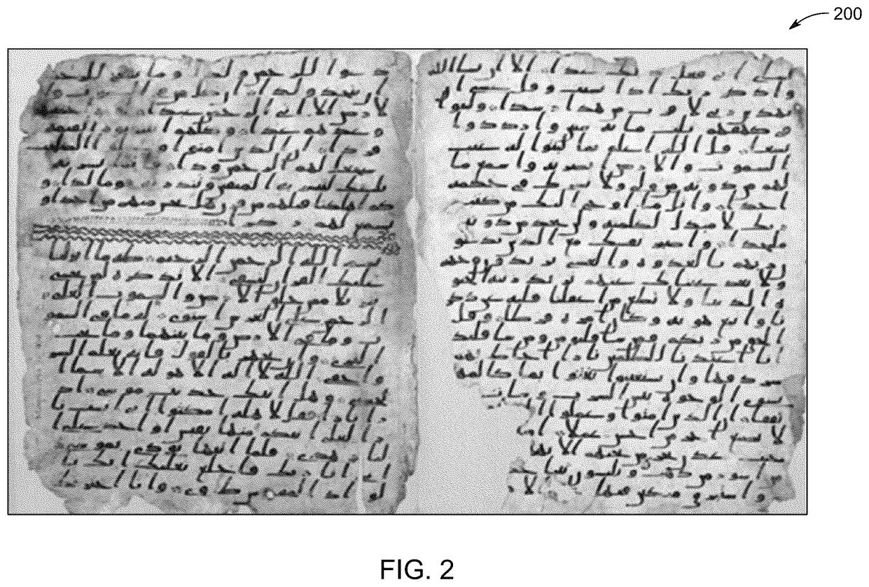

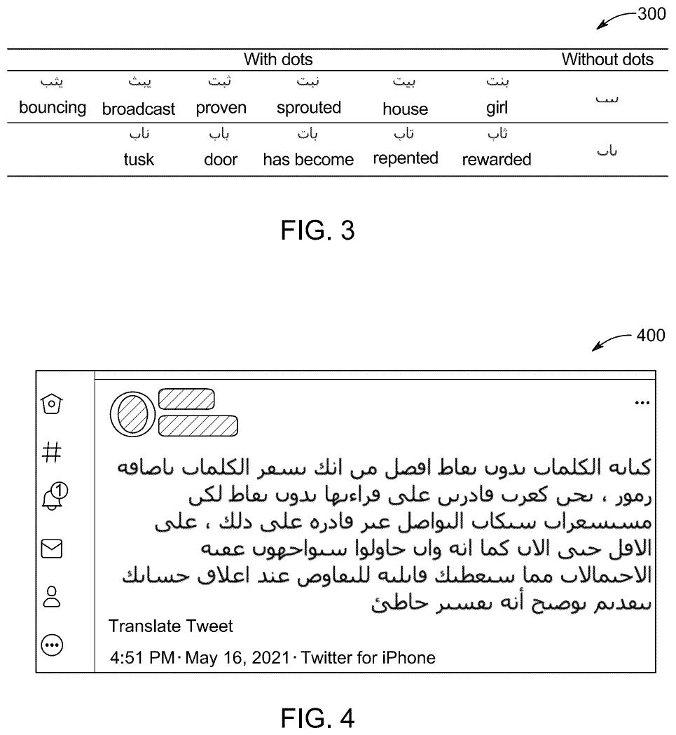

The present method 600 for automatically adding dots to Arabic text utilizes deep learning. In particular, recurrent neural networks (RNNs) are employed to add dots to a sequence of Arabic text. Since the input is a sentence without dots and the output is the same sentence with dots, the present method 600 preferably adopts the sequence-to-sequence (Seq2Seq) learning approach. Moreover, there is a direct one-to-one mapping between the input and the output. The input sequence can be obtained from different sources depending on the context. For example, to add dots to ancient Arabic manuscripts (e.g., as shown in FIG. 2), it may first involve recognizing Arabic Rasms from text images; and once the Rasms are recognized, as a sequence of machine-readable symbols, the proposed techniques may be used to add dots to them. Alternatively, in the context of digital media (e.g., exemplary text posted as “tweet,” as shown in FIG. 4), the Rasm sequence is already available in machine readable format, and the proposed techniques may directly be used to add dots to the Rasm sequence. Yet another use case is to perform Arabic text recognition by first recognizing the Rasms from the text images and then automatically adding dots using the proposed techniques or by combining this information with the visual clues about the dots available in the text images.

In particular, at step 602, the method 600 begins with converting Arabic text having one or more Arabic Rasms without dots to an input sequence of machine-readable symbols. Such conversion involves transitioning from a traditional or digital representation of each of the Arabic Rasm of the Arabic Rasms to a format suitable for computational processing. The Arabic Rasm, inherently, may be present in various forms, such as, part of a historical manuscript, a modern-day digital document, or even a pictorial representation in an image or a scanned document. For purposes of the present disclosure, regardless of its source, the Rasm needs to be in a format that is compatible with digital processing tools, algorithms, and neural networks. The conversion process may involve recognizing individual letters, words, and other relevant components of the script. Such techniques are known in the art, and thus not explained herein for brevity of the present disclosure. The output of this conversion is an input sequence that digitally represents the Arabic Rasm in the form of machine-readable symbols. This ensures that the Rasm, whether sourced from a manuscript, a text image, or a digital sequence, can be processed digitally.

Following this conversion, at step 604, the method 600 includes normalizing the input to be used by neural network system (as described later). Normalizing involves removing one or more components from the input sequence generating a normalized sequence. This data cleaning step is part of pre-processing data before feeding the data to the machine learning system. As may be appreciated, the datasets may contain non-Arabic digits and punctuation marks. These components are needed to be removed to eliminate potential ambiguities and variations that could hinder subsequent processing stages. Herein, the one or more components include at least one of a URL, a symbol, a punctuation mark, a white space, a diacritic, and a Kashida character. URLs may be interspersed within the text, which while informative in some contexts, are irrelevant for the dottization process and can introduce noise. Symbols that are not intrinsic to the Arabic script or do not carry semantic meaning within the context of the Arabic Rasm are also considered for removal. While punctuation marks can provide syntactic cues in regular text, for the purpose of dottization, punctuation marks may not always contribute to the understanding of the Arabic script's structural integrity. Similarly, white spaces can disrupt the continuity of the script and thus removed. Regular expressions may be employed to remove URLs, symbols, punctuation marks and extra white spaces. Also, since the focus is on the Rasm, which is inherently devoid of diacritical marks, removing diacritics ensures that the process is focused. Further, Kashida is used for aesthetic reasons. It is used to make the words look longer without affecting the meaning. For example, using Kashida in the word [symbol] can render the word [symbol] Kashida may not be semantically required in the context of dottization and is thus removed. The act of removing these components serves to simplify the sequence, focusing only on the core elements of the Arabic Rasm that are relevant to the dottization process.

Further, at step 606, the method 600 includes consolidating a set of characters appearing in diverse forms in the normalized sequence into a single form of character. The Arabic script, by its inherent nature, has a unique feature wherein individual characters can manifest in different character forms based on their placement within a word. Specifically, an Arabic character can assume varied visual forms when it is situated at the beginning, middle, or end of a word. Furthermore, characters can also appear in an isolated form when they stand alone. This variability in character representation, while integral to the script's functionality, introduces an added layer of complexity when it comes to digital processing, especially in the context of dottization. This step of consolidation of characters is dedicated to addressing the aforementioned variability in character forms. Consolidation is the process of unifying or standardizing the diverse forms of a specific character present in the normalized sequence. The goal is to represent each character in its base or standard form, irrespective of its original positional form in the sequence. For example, this process may unify [symbol] to the simple form [symbol] By ensuring that each character has a single representation, the process minimizes ambiguities that could arise from multiple forms of the same character, and ensures that all instances of a particular character, regardless of where they appear in a word or the sequence, are treated uniformly during subsequent processing stages. Further, with this approach, neural networks or other processing tools that may be employed may not need to account for multiple forms of the same character, leading to faster and more efficient processing.

Upon consolidation, at step 608, the method 600 includes performing a tokenization on the consolidated sequence generating a plurality of tokens. Tokenization is a fundamental step in natural language processing (NLP) and computational linguistics tasks. Tokenization involves segmenting a larger sequence into smaller units, commonly referred to as tokens. Herein, after the consolidation process has streamlined the characters in the normalized sequence to their singular forms, this consolidated sequence is tokenized to be used by neural network system (as described later). In the present implementations, two different tokenization schemes are evaluated: words as tokens (word-level tokenization) and characters as tokens (character-level tokenization).

That is, in an embodiment, each token of the plurality of tokens is a word sequence. Herein, when tokens are defined as word sequences, each token represents an entire word or a sequence of letters that form a meaningful unit within the Arabic script. In the word-level tokenization approach, sequences of word Rasms are used as the primary units for input to a model (like a machine learning model), and the corresponding sequence of words is output by the model with each word as a unit (i.e., an output consisting of sequences of fully formed words). Words inherently include a rich and condensed representation of text when compared against individual character sequences. This provides a nuanced understanding of the Arabic Rasm. Moreover, certain word Rasms have a unique mapping to specific Arabic words, making the prediction task straightforward for those particular word Rasms. However, word-level tokenization has challenges related to out-of-vocabulary (OOV) words. These are words that appear in the evaluation set but were not encountered during the training phase. Furthermore, the extensive vocabulary size associated with word-level models presents difficulties, primarily due to data imbalance. This imbalance arises as numerous words in the training set might be infrequent, thus posing challenges during the dottization process. That said, however, many word Rasms map to unique Arabic words. Thus, with the word-level tokenization approach, predicting the correct word for those input word Rasms may be relatively straightforward.

And, in another embodiment, each token of the plurality of tokens is a character sequence of an Arabic script. Herein, each token represents an individual character or a sequence of letters from the Arabic script. In the character-level tokenization, the input is constituted by sequences of distinct tokens, each representing possible character Rasms. The subsequent output is a sequence including the 28 distinct characters present in the Arabic script. The character-level tokenization is able to overcome some of the challenges inherent to the word-level approach, such as a reduced vocabulary size and enhanced adaptability in managing OOV words. However, the sequence becomes significantly longer, and modeling long-range dependencies is a challenge when using the character-level model. Accordingly, deeper architectures are needed to accurately capture the context.

In this embodiment, a character in the character sequence comprises a character shape depending on a position of the character in the character sequence. The Arabic script is distinctively characterized by its positional variability. An individual Arabic character can assume different visual forms based on its placement within a word, be it at the beginning, middle, or end. Therefore, in character-level tokenization, when using character Rasms as tokens, position-dependent Rasms of the characters are used instead of using one Rasm for a character irrespective of its position in a word. This is done because in Arabic script, a character can take different shapes based on its position in a word (as discussed). For example, the character [symbol] has the same shape in the beginning and in the middle of a word as characters [symbol] [symbol] On the other hand, the character [symbol] has the same shape in all positions of the word as characters [symbol] Accounting for these positional forms ensures that the tokenization process is attuned to the intricate nuances of the Arabic script, providing a more accurate representation of the Arabic Rasm in the subsequent processing stages.

Therefore, in present embodiments, a type of the plurality of tokens is at least one of a word token and a character token. That is, the tokens generated from the consolidated sequence may either be word tokens or character tokens, or even a combination of both, depending on the chosen tokenization approach. The word tokens are generated when the tokenization is executed at a word-level granularity (i.e., word-level tokenization), and each token represents a word or a sequence of letters that together form a meaningful unit within the Arabic script. The word tokens capture the semantics and context inherent within whole words. Whereas the character tokens are generated by character-level tokenization which breaks down the consolidated sequence into individual characters or letters from the Arabic script. The character tokens offer granularity, ensuring a detailed and nuanced representation of the Arabic Rasm. Each type of token offers its own set of advantages and challenges, and the choice between the word tokens and the character tokens, or even a hybrid approach, is informed by the specific requirements and challenges of the dottization task.

In some embodiments, the method 600 employs a baseline system that leverages character unigrams to predict the character sequence based on the provided input sequence of character Rasms. A unigram, in computational linguistics and natural language processing, refers to a single unit or token. In the context of this baseline system, a character unigram represents an individual character from the Arabic script. This approach establishes a benchmark against which the other techniques (like the character-level tokenization and the word-level tokenization) can be evaluated. Such baseline systems are used in research and development as they provide a reference point, ensuring that the more advanced systems indeed offer added value and improvements.

After tokenization, at step 610, the method 600 includes applying a padding to a first end and to a second end of each token of the plurality of tokens. In neural network models, especially those dealing with sequence data, often require input data to be of a consistent length. Padding is the process of adding layers of zeros or other values outside the actual data in an input data matrix to manage the spatial dimension (i.e., the length) of the input data matrix. The padding ensures that each token has a consistent length, facilitating more uniform processing by the neural network. The choice of padding value or symbol is typically something neutral, ensuring that the neural network does not misconstrue it as meaningful data. In the present disclosure, each token of the plurality of tokens is the input data matrix. The padding is systematically applied to both the first end (beginning) and the second end (end) of each token. By adding padding to both ends of a token, the method 600 ensures that the core information of the token, i.e., the original characters or words from the Arabic Rasm, remains centrally positioned and unaltered, thus ensuring a symmetrical and balanced extension of the token's length. Herein, the padding is applied based on the maximum number of tokens an input line can have. Keeping all the input lines to the same length using padding leads to performance improvements in terms of training and inference times

At step 612, the method 600 includes inputting the plurality of tokens to a recurrent neural network for processing. That is, after the tokenization and padding phase, the plurality of tokens, including the word tokens, the character tokens, or a combination thereof, are fed as input into the recurrent neural network (RNN) for further processing. The RNN (sometimes, simply, referred to as “network” without any limitations) is particularly suitable for handling sequential data due to its internal mechanisms, which allow it to maintain a form of memory of previous inputs in the sequence. When the tokens are inputted into the RNN, the network processes them in sequence, with each token influencing the internal state of the network. This internal state, often referred to as the hidden state, captures the contextual information of the processed tokens. As the RNN processes each token in the sequence, it updates its hidden state, ensuring that the context and relationships between tokens are preserved and utilized for subsequent predictions or mappings.

Herein, the recurrent neural network is trained by mapping between an input and an output of the recurrent neural network. That is, the training of the RNN is directed towards mapping between the input sequence (tokens derived from the Arabic Rasms) and the desired output sequence (the dottized version of the Arabic Rasms). The training process utilizes a dataset wherein both the input sequences and their corresponding desired outputs are known. By training the RNN to these known input-output pairs, the RNN learns to adjust its parameters to minimize the difference between its predicted output and the actual desired output. The trained RNN can then be utilized on new input sequences to predict or map them to their corresponding dottized versions.

In an embodiment, the recurrent neural network employs a sequence-to-sequence learning approach. The sequence-to-sequence (Seq2Seq) learning approach is utilized in deep learning, especially for tasks that involve sequential input and output data. A Seq2Seq model is primarily composed of two main components: an encoder and a decoder, both of which are typically implemented using RNNs. The encoder processes the input sequence (in this case, the tokenized Arabic Rasms) and compresses the information into a fixed-size context vector. The decoder uses the context vector produced by the encoder to generate the output sequence. Starting with the context vector, the decoder predicts the tokens of the output sequence one by one. Each predicted token, in turn, influences the subsequent predictions, ensuring that the output sequence is generated in a contextually coherent manner. In the present implementation, the use of the Seq2Seq learning approach within the RNN framework amplifies its capability to map the tokenized Arabic Rasm sequences to their corresponding dottized versions.

In certain embodiments, the recurrent neural network is a bidirectional recurrent neural network. When the context of the input is available and important from both directions, the bidirectional RNNs can prove to be more effective. The bidirectional RNNs have the same output for two connected hidden layers from opposite directions. The bidirectional RNN generally consists of two separate RNNs: a forward RNN which processes the sequence in its natural order, starting from the first token and moving towards the last; and a backward RNN which processes the sequence in the reverse order, starting from the last token and moving towards the first. The bidirectional RNN combines hidden states of both the forward and backward RNNs at each time step, such that the prediction for each token is informed by both its preceding and following tokens. This ensures that the dottization process is both accurate and thorough.

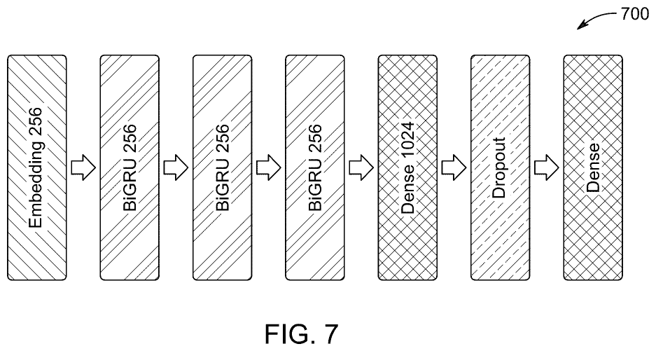

In the present implementations, to ensure dottization of the Arabic Rasm, a comprehensive processing pipeline may need to be executed within the RNN. FIG. 7 is a schematic representation of an architecture (as represented by reference numeral 700) as implemented by the RNN for dottization of the Arabic Rasm, in the embodiments of the present disclosure. The architecture 700 (as shown) is able to accommodate character Rasms as the input tokens. It may be understood that the hyperparameters for each component, such as the depth (number of layers) and breadth (number of units within each layer), may be calibrated based on the performance metrics observed on the validation set, as discussed further in detail in the proceeding paragraphs.

The processing by the recurrent neural network, first, includes converting the plurality of tokens to a plurality of dense vectors utilizing an embedding layer. Herein, the embedding layer includes a plurality of dense embeddings. As used herein, the “embedding layer” is a specialized neural network layer that contains a lookup table. Each token is associated with a specific vector in this lookup table, and when a token is passed through the embedding layer, it retrieves its corresponding vector representation. In an exemplary configuration, as illustrated in FIG. 7, the embedding layer possesses an embedding size of 256, meaning each unique token is mapped to a dense vector of 256 dimensions. This step transforms the tokens, which are typically discrete and categorical in nature, into continuous vector representations. This transformation facilitates the capture of semantic relationships between tokens, ensuring that tokens with similar meanings or roles have similar vector representations.

The processing by the recurrent neural network, then, includes processing the plurality of dense vectors utilizing a consecutive set of gated recurrent units. That is, post the embedding phase, the output derived is channeled to the recurrent neural networks (RNNs). This is done to process the sequence of embeddings and capture the temporal relationships and dependencies between tokens. To interpret the mapping between the input and the subsequent output, several RNN layers are stacked upon one another. It may be noted that when the input tokens are characterized by character Rasms, the architecture requires a more detailed structure, necessitating additional RNN layers in contrast to when word Rasms serve as the input tokens. During the development phase, various RNN units were put to the test, including long short-term memory (LSTM), and gated recurrent units (GRUs). Among these, the GRUs, despite having fewer parameters in comparison to LSTMs, produced excellent results on the validation dataset. Gated recurrent units are a type of recurrent neural network architecture that have specialized mechanisms, termed gates, which control the flow of information through the unit. These gates determine what information to retain, discard, or update at each time step, making GRUs adept at managing long-range dependencies in sequences. Herein, the consecutive set of gated recurrent units map the input to the output for training the recurrent neural network. In an exemplary configuration, as illustrated in FIG. 7, three consecutive Bidirectional Gated Recurrent Unit (BiGRU) layers are utilized. Each of these three BiGRU layers has 256 units, which denotes the capacity of each layer to maintain and process contextual information. By processing the embeddings with GRUs, the RNN is able to capture the intricate patterns and relationships in the Arabic Rasm sequence.

In the present implementation, the method 600 further includes determining a count of gated recurrent units in the consecutive set of gated recurrent units corresponding to a type of the plurality of tokens. Given that the RNN needs to work with different granularities, such as character Rasms or word Rasms as tokens, the complexity and demands of each type differ. For instance, when character Rasms serve as input tokens, the architecture requires a deeper structure, which translates to more GRU layers, as compared to when word Rasms act as input tokens. This is because character-level processing requires the network to capture finer details and relationships within the sequence. By determining the count of GRUs based on the type of token, the method 600 ensures that the RNN is equipped to handle the specific challenges associated with each token type.

The processing by the recurrent neural network further includes performing a rectified linear unit (ReLU) activation on the processed output utilizing a fully connected dense layer. This is done to introduce non-linearity into the network's computations, enabling it to capture complex relationships and patterns. A fully connected dense layer connects every neuron from the previous layer to every neuron in its own layer. In an exemplary configuration, as illustrated in FIG. 7, the architecture 700 incorporates a fully connected dense layer of 1024 units. The high dimensionality of this layer allows it to produce a wide range of outputs, catering to the diverse nature of dottization task of the Arabic Rasm. After the weighted summation in this layer, the ReLU activation function is applied, which replaces negative values with zeros and retains positive values as they are. The introduction of non-linearity ensures that the network can model intricate and non-linear relationships in the data.

The processing by the recurrent neural network, subsequently, includes reducing overfitting utilizing a dropout layer. In an exemplary configuration, as illustrated in FIG. 7, the dropout layer is positioned after the dense layer of 1024 units. The dropout layer randomly deactivates a subset of its neurons during training. This means that these neurons do not participate in forward or backward passes for a particular iteration. This prevents the RNN from becoming too reliant on specific patterns in the training data, thereby improving its generalization to new data.

The processing by the recurrent neural network, further, includes generating a SoftMax activation function through a dense layer. That is, the output is then routed to another dense layer, this time equipped with the SoftMax activation function. In an exemplary configuration, as illustrated in FIG. 7, the final layer in the architecture 700 is another dense layer, but this one incorporates a SoftMax activation function. The SoftMax activation function exposes its input and then normalizes it, ensuring that the output values lie between 0 and 1 and that they sum up to 1. When applied after a dense layer, it provides the probability distribution of the possible outputs. Therefore, in tasks like dottization, where the goal is to predict the correct output token for a given input, the SoftMax activation provides a clear probabilistic measure of the network's predictions.

In the present implementation, the method 600 further includes determining a count of units in the dense layer corresponding to a type of the plurality of tokens. It may be contemplated that the number of units in the dense layer is intrinsically linked to the modeling approach. If the word-level tokenization is employed, the unit count in this dense layer aligns with the number of unique words present in the training dataset, allowing the network to produce a probability distribution over all possible word outputs. On the other hand, in the character-level tokenization, the unit count aligns with the total characters in the Arabic script, which stands at 28 (as discussed). This ensures that the network is able to output a probability distribution for each character in the Arabic script.

Referring back to FIG. 6, at step 614, the method 600 includes mapping an output sequence of the recurrent neural network to an Arabic word, wherein the output sequence is the Arabic Rasm with dots. It was observed (as discussed later in Experimental Data section in detail) that while the character-based model, using character Rasms as input tokens, demonstrated superior performance, many word Rasms consistently mapped to a singular Arabic word in the training data. Therefore, in the dottization process of Arabic Rasm, a postprocessing phase was introduced to bolster the process accuracy leveraging this insight. Herein, after the character-based system outputted the sequence for an input sentence, an inspection was undertaken at the word level. If a word Rasm consistently linked to a specific Arabic word in the training set, the output for that word was substituted with the corresponding Arabic word from a pre-constructed dictionary. This approach integrated the precision of character-based predictions with the reliability of word-level mappings, ensuring enhanced accuracy in dottization of the Arabic Rasm.

Further, at step 616, the method 600 includes mapping each word/Rasm with dots in the output sequence of Arabic text with dots to each word/Rasm in the input sequence of Arabic text without dots for generating a training set for the recurrent neural network. As discussed, when it is identified that a particular word Rasm from the one or more Rasms in the output sequence aligns with a consistent Arabic word mapping in the training set, it is substituted with the initial output of the RNN for that specific word. This substitution is done based on a pre-established dictionary, from a training set, which contains mappings of word Rasms to their respective Arabic words. This dictionary acts as a reference point, ensuring that the output sequence aligns with the most probable and consistent mappings known from the training data. Herein, this revised output sequence, now mapped back to its Arabic Rasm form, serves as an additional data point for the training set of the RNN. By doing so, the process not only leverages its current predictions but also integrates consistent patterns into the training set that refines the RNN's performance.

In the present embodiments, the method 600 further comprises selecting the Arabic Rasm from at least one of an Arabic manuscript, the Arabic Rasm obtained from a text image, and a digital Rasm sequence, based on available format of particular Arabic scripts that need addition of dots to the Arabic texts in it. Recognizing the diverse sources of the Arabic script, the method 600 is designed to be versatile and adaptive to various forms and formats of Arabic Rasm. For instance, the method 600 is equipped to extract Arabic Rasm from traditional Arabic manuscripts, which are often handwritten and representative of historical or classical Arabic literature, and thus allows for preserving and understanding the classical form of the language. The ability of the method 600 to derive Arabic Rasm from text images, such as scanned documents, photographs of written text, or digital graphics, ensures that even if the Arabic text is not in a machine-readable format, it can still be processed and dottized. Further, the ability of the method 600 to work with digital Rasm sequences, which may include Arabic content in digital platforms, websites, ebooks, and other electronic formats, ensures that it remains relevant and effective in contemporary contexts.

A second aspect of the present disclosure provides a system for dottization of the Arabic Rasm. Various embodiments and variants disclosed above, with respect to the aforementioned method, apply to the present system.

The system includes a processing circuitry. The processing circuitry is configured to convert the Arabic Rasm to the input sequence of machine-readable symbols. The processing circuitry is further configured to remove one or more components from the input sequence to generate the normalized sequence. Herein, the one or more components include at least one of the URL, the symbol, the punctuation mark, the white space, the diacritic, and the Kashida character. The processing circuitry is further configured to consolidate the set of characters appearing in diverse forms in the normalized sequence into the single form of character. The processing circuitry is further configured to perform the tokenization on the consolidated sequence to generate the plurality of tokens. The processing circuitry is further configured to apply the padding to the first end and at the second end of each token of the plurality of tokens. The processing circuitry is further configured to input the plurality of tokens to the recurrent neural network for processing. Herein, the training of the recurrent neural network is achieved by mapping the input to the output. The processing circuitry is further configured to map the output sequence of the recurrent neural network to the Arabic word. Herein, the output sequence is the Arabic Rasm with dots. The processing circuitry is further configured to map the output sequence to the Arabic Rasm as the training set for the recurrent neural network.

The plurality of tokens includes at least one of the word token and the character token.

The character in the character token comprises the character shape depending on the position of the character in the character token.

The recurrent neural network is the bidirectional recurrent neural network.

The processing circuitry is further configured to convert the plurality of tokens to the plurality of dense vectors utilizing the embedding layer. Herein, the embedding layer comprises the plurality of dense embeddings. The processing circuitry is further configured to process the plurality of dense vectors utilizing the consecutive set of gated recurrent units. Herein, the consecutive set of gated recurrent units maps the input to the output for training the recurrent neural network. The processing circuitry is further configured to perform the rectified linear unit activation on the processed output utilizing the fully connected dense layer. The processing circuitry is further configured to reduce overfitting utilizing the dropout layer. The processing circuitry is further configured to generate the SoftMax activation function through the dense layer.

The count of gated recurrent units in the consecutive set of gated recurrent units is corresponding to the type of the plurality of tokens.

The count of units in the dense layer is corresponding to the type of the plurality of tokens.

The Arabic Rasm is at least one of the Arabic manuscripts, the Arabic Rasm obtained from the text image, and the digital Rasm sequence.

### Examples

### Datasets

Herein, the datasets used for the experiments in addition to the preprocessing and tokenization carried out before feeding the data to the present system are presented. To train and test the proposed models, four diverse corpora were used. Each corpus is explained below:

Poem corpus: Poem corpus is a publicly available corpus [M. S. Al-Shaibani, Z. Alyafeai, I. Ahmad, Metrec: a dataset for meter classification of Arabic poetry, Data Brief 33 (2020) 106497; incorporated herein by reference in its entirety]. The dataset was collected from an online public resource. Most of the samples were taken from (https://www.aldiwan.net/). It consists of a total of 55,440 poem verses.

Tashkeela corpus: A dataset extracted from the Tashkeela corpus was presented [A. Fadel, I. Tuffaha, M. Al-Ayyoub, et al., Arabic text diacritization using deep neural networks, 2nd International Conference on Computer Applications & Information Security (ICCAIS), IEEE, 2019, pp. 1-7; incorporated by reference]. Tashkeela consists of 97 classical Arabic books and 293 modern standard Arabic documents compiled from books, articles, news, speeches, and school lessons. In this work, a subset of the Tashkeela corpus by taking sentences up to 70 words in length was used. The maximum number of words was limited to 70 due to memory limitations.

ATB corpus: The Arabic Treebank-Weblog corpus was combined with Arabic Treebank Part-two version 3.1 from the Linguistic Data Consortium (LDC) (https://www.ldc.upenn.edu/) to create the ATB corpus for experimentation.

Quran corpus: The work was also evaluated on the Quran text. The text was used from Tanzil (http://tanzil.net/docs/home), which is an international Quran project.

15% of each corpus was used as the test sets, and 15% of the remaining 85% of the data was used as validation sets for system calibration and hyperparameter tuning. The split for all the datasets is done at the line level.

In Table 1, important statistics for each of the four datasets are presented. The SRILM language modeling toolkit was used to compute the OOV rate and other corpus statistics, as in Stolcke [A. Stolcke, Srilm—an extensible language modeling toolkit, in: Seventh International Conference on Spoken Language processing, 2002, pp. 901-904; incorporated herein by reference in its entirety]. From the table, it can be seen that Tashkeela is the largest corpus in terms of the number of word tokens and in terms of the total number of characters. The Quran corpus is the smallest in terms of the total number of words. The Poem corpus has the largest vocabulary size, i.e., number of unique words in the training set, although it is significantly smaller than the Tashkeela corpus in terms of the total number of words. Additionally, the Poem dataset has the highest out of vocabulary (OOV) rate on both the validation and the test sets. This indicates that a more diverse and complex vocabulary is used in the Poem dataset compared to other datasets. The Quran dataset has the second highest OOV rate. The Tashkeela dataset has the smallest OOV rate among the four datasets.

TABLE 1
Important statistics from the four datasets used in the experiments

| | | | | | Validation set | | | Test set | | |
|---|---|---|---|---|---|---|---|---|---|---|
| | Training set | | | | | | OOV | | | OOV |
| Dataset | N_{w} | V_{w} | Vᵣ | N_{c} | N_{w} | N_{c} | (%) | N_{w} | N_{c} | (%) |
| Poem | 3,62,906 | 85,425 | 68,218 | 14,85,534 | 64,059 | 2,62,334 | 9334 | 75,317 | 3,08,979 | 10,975 |
| | | | | | | | (14.6) | | | (14.6) |
| Tashkeela | 6,43,327 | 58,479 | 50,002 | 25,47,686 | 1,13,211 | 4,48,403 | 5724 | 1,32,872 | 5,26,326 | 6709 |
| | | | | | | | (5.1) | | | (5.1) |
| ATB | 3,22,532 | 63,038 | 54,629 | 15,17,371 | 56,901 | 2,67,848 | 6383 | 58,490 | 2,68,182 | 5080 |
| | | | | | | | (11.2) | | | (8.7) |
| Quran | 50,175 | 11,280 | 10,333 | 2,12,617 | 8564 | 36,789 | 1239 | 18,427 | 79,016 | 2695 |
| | | | | | | | (14.5) | | | (14.6) |

### Evaluation Metrics

In this section, the measures used to evaluate the performance of the models are presented.

Character error rate (CER): The CER was reported when evaluating the systems. It is defined as follows:

$$CER = \frac{{S}_{C}}{{N}_{C}} \times 100 \qquad ( 1 )$$

where S_{C} is the number of incorrectly predicted characters and N_{C} is the total number of characters in the evaluation set. It should be noted here that Sc is the sum of insertion, deletion, and substitution errors.

Word error rate (WER): The WER is used as an additional measure. It is defined as follows:

$$CER = \frac{{S}_{W}}{{N}_{W}} \times 100 \qquad ( 2 )$$

where S_{W} is the number of incorrectly predicted words and N_{W} is the total number of words in the evaluation set. It should be noted here that Sw is the sum of insertion, deletion, and substitution errors.

Dottization error rate (DoER): The DoER is a new measure proposed to interpret the results more objectively in this new task. There are characters in Arabic that have no dots and have unique Rasms that can never be predicted incorrectly by the system. Thus, to obtain an unbiased score, the DoER is also reported, which is defined as follows:

$$CER = \frac{{S}_{C}}{{N}_{R}} \times 100 \qquad ( 3 )$$

where S_{C} is the number of incorrectly predicted characters and N_{R} is the total number of Rasms in the evaluation set that can have dots. As N_{R} is always less than N_{C}, DoER will always be higher than CER.

### System Training and Calibration

Keras along with TensorFlow as the backend were used to implement the system. All experiments were conducted on the Co-lab and Kaggle platforms provided by Google. The hyperparameters were calibrated by either using the typical values reported in the literature or by optimizing the performance on the validation set, independent of the test set. Categorical cross-entropy loss was used to train the system along with the Adam optimizer. The maximum epochs of training were set to 30. A batch size of 128 samples was used when training the system, and the system was evaluated on the validation set at the end of each training epoch. The loss was monitored on the validation set to save the best model having the least loss on the validation set. If the loss on the validation set does not improve for two epochs, the learning rate was reduced by a factor of 0.1. Early stopping was also employed, whereby the training stops if the validation loss does not improve for four epochs. A dropout rate of 0.3 was used to reduce overfitting.

### Results and Discussion

The first set of experiments used the word Rasms as input tokens. In Table 2, the dottization results using the word tokens is summarized. It may be observed from that table that the error rates are high for all four datasets. This is mainly due to the issue of OOV words and also because many words were infrequent in the training set. The results on the Tashkeela dataset are the best. This can be explained by the fact that it has the largest training set in terms of the number of words and has the smallest OOV rate, as seen from Table 1.

TABLE 2
Summary of the results using the word-based system

| | Validation set | | | Test set | | |
|---|---|---|---|---|---|---|
| Dataset | CER | DoER | WER | CER | DoER | WER |
| Poem | 25.1 | 29.5 | 27.7 | 25.1 | 29.6 | 27.8 |
| Tashkeela | 13.3 | 15.8 | 13 | 13.3 | 15.7 | 12.9 |
| ATB | 22.1 | 25.2 | 23.3 | 18.1 | 21.1 | 18.8 |
| Quran | 31.9 | 38.4 | 29.7 | 32 | 38.9 | 29.4 |

To obtain a better understanding of the results, the results of the baseline system are presented, which uses character unigrams to predict the character sequence given the character Rasms, in Table 3. Comparing the results in Table 2 to the baseline system in Table 3, it may be observed that the word-level system performs significantly better in terms of DoER and WER compared to the baseline system. The CERs of the word-based systems perform better than the baseline systems on some datasets and worse on other datasets. This can be explained by the fact that the word-level system not only makes errors on Rasms that can have dots, as is the case of the baseline system, but it also makes errors for other characters due to the OOV issue. The Tashkeela dataset has the lowest OOV rate (cf. Table 1), and the word-based system performs best on this dataset in terms of CERs as compared to the baseline system. On the other hand, the Quran and Poem datasets have the highest OOV rates, and the word-based systems have worse results as compared to the baseline system. The Quran dataset is also the smallest in training set size which may explain further deterioration in results.

TABLE 3
Summary of the results using the baseline system

| | Validation set | | | Test set | | |
|---|---|---|---|---|---|---|
| Dataset | CER | DoER | WER | CER | DoER | WER |
| Poem | 22.1 | 42 | 60 | 22.1 | 42.1 | 60.3 |
| Tashkeela | 25.1 | 46.1 | 59.7 | 25.1 | 46 | 59.6 |
| ATB | 27 | 47.2 | 66.9 | 30.3 | 49.1 | 66.6 |
| Quran | 19.7 | 43.2 | 58.3 | 19.5 | 44.9 | 56.5 |

The next set of experiments used the character Rasms as input tokens. In Table 4, the dottization results using the character system are summarized. It may be observed from the table that the character system's performance is very impressive, and the results are significantly better compared to the word system for all the three metrics. This shows the effectiveness of the presented techniques for the Arabic dottization task. The best results using the character system are for the Tashkeela dataset, and the second-best results are for the ATB dataset. The highest error rates are for the Poem dataset. The use of complex vocabulary and uncommon words in poems can be a possible explanation for this.

TABLE 4
Summary of the results using the character-based system

| | Validation set | | | Test set | | |
|---|---|---|---|---|---|---|
| Dataset | CER | DoER | WER | CER | DoER | WER |
| Poem | 5.5 | 10.9 | 17.3 | 5.6 | 11.2 | 17.7 |
| Tashkeela | 2.2 | 4.6 | 6.8 | 2.2 | 4.4 | 6.7 |
| ATB | 3.2 | 6.5 | 11.6 | 2.7 | 5.4 | 9.4 |
| Quran | 4 | 8.8 | 13.7 | 3.8 | 8.7 | 12.8 |

The final set of results were obtained after applying the postprocessing step (as discussed). The results are summarized in Table 5. It may be seen from the table that small but significant improvements are achieved for all four datasets. For example, the significance interval at the 95% confidence level on the Tashkeela test set are ±0.03, ±0.05, and ±0.11 for CER, DoER, and WER, respectively, using the statistical test for the difference of two proportions, as presented in Dietterich [T. G. Dietterich, Approximate statistical tests for comparing supervised classification learning algorithms, Neural Comput. 10 (7) (1998) 1895-1923; incorporated herein by reference in its entirety].

TABLE 5
Summary of the results after postprocessing

| | Validation set | | | Test set | | |
|---|---|---|---|---|---|---|
| Dataset | CER | DoER | WER | CER | DoER | WER |
| Poem | 5.4 | 10.7 | 16.8 | 5.5 | 11 | 17.2 |
| Tashkeela | 2.1 | 4.4 | 6.4 | 2 | 4.2 | 6.3 |
| ATB | 3 | 6.1 | 10.8 | 2.6 | 5.3 | 9.1 |
| Quran | 3.3 | 7.2 | 10.8 | 3.7 | 7.8 | 10.8 |

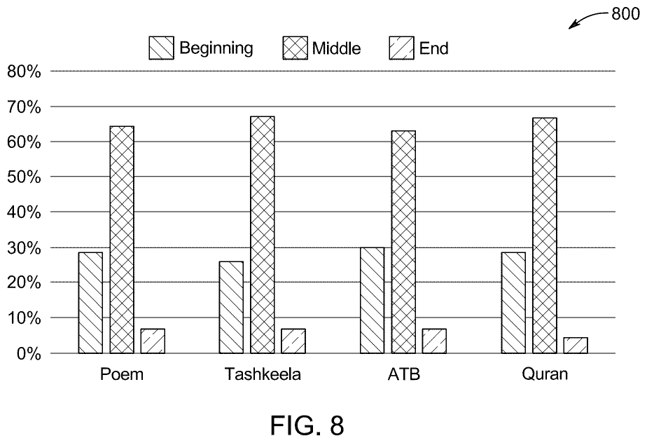

In order to investigate the errors, the incorrectly predicted characters were counted according to their positions in the words and the frequency of the incorrectly predicted words. Additionally, the mistakes based on different positions a character can take in a word were also counted. FIG. 8 presents a graph (as represented by reference numeral 800) plotting percentage of error characters based on their positions in the words. As may be seen, relatively few errors occur for the characters taking the last position in words compared to characters in the beginning of the words or in the middle. One of the main reasons for this is due to the characters that are used as prefixes in Arabic words. Specifically, the prefixes related to different verb forms lead to most of the confusion. As an example, the prefix in the word (takun) was predicted incorrectly as (yakun). It should be noted that the middle position has more than one character in words having four or more characters. As such, the number of mistakes in the middle position is cumulative and it is relatively high for all the datasets.

The frequency of incorrectly predicted words or sub-words could also be a cause of some errors. The sub-word, also known as parts-of-Arabic-word (PAWs), is a sequence of characters connected to other characters with a word. If an incorrectly predicted word or sub-word is more frequent than the correct word in the training set, it may influence the model's output. The model may output the more common word or sub-word for an input Rasm sequence, as a result. For instance, from the Poem dataset, the word (hasrati) was predicted incorrectly as (hasruni). The sub-word (rati) appears 141 times in this case compared to the sub-word (runi), which appears 222 times in the training set of the Poem dataset.

The character-level model solves the OOV issue, which was the main cause of error for the word-level model. However, character-level models suffer from misspelled word errors since the model is trained on sequences of characters and not words. Thus, incorrect words that do not belong to the language could be output from the character-level model. For instance, a misspelled word [symbol] (alhatiqiyah) is output by the model when evaluated on the ATB dataset in place of the correct word [symbol] (alhatifiyah). Spelling correction could be applied as a postprocessing step to solve the misspelled word errors.

Thereby, the present disclosure provides automatic dottization of Arabic text (or specifically, Arabic Rasm). The present disclosure offers a comprehensive solution for the dottization of Arabic Rasm. By integrating advanced neural network architectures with preprocessing and postprocessing steps, the present disclosure addresses the inherent challenges posed by the Arabic script. Moreover, two different approaches were investigated: one using words as tokens and the other using characters as tokens. The benefits and limitations of both approaches were discussed although overall, the character-level system outperformed the word-level system. A postprocessing step led to further small but significant improvements. Four publicly available datasets were used to evaluate the presented techniques, with the character error rates ranging from 2.0% to 5.5% and the dottization error rates ranging from 4.2% to 11.0% on the independent test sets. Based on the error analysis, it was discovered that prefixes confusion is the main source of errors, which is understandable for languages such as Arabic, where words are highly inflected. In addition, the frequency of word or sub-word sequences that appear significantly more in the training set compared to other words or sub-words can also contribute to errors.

The proposed method 600 of the present disclosure offers several distinct advantages over traditional rule-based systems or other known methods. By leveraging the power of recurrent neural networks, the method 600 can adapt to variations, errors, or nuances in the Arabic Rasm, ensuring high accuracy in real-world scenarios. The bidirectional nature of the RNN, in certain embodiments, further boosts this adaptability by considering both past and future contexts. Also, the inclusion of layers like the dropout layer and the embedding layer ensures that the model not only generalizes well to new data but also captures the semantic nuances of the Arabic script. The SoftMax activation function ensures that the output is probabilistically accurate, offering multiple potential dotted versions and allowing for flexibility in choosing the most appropriate one. Further, by consolidating diverse character forms and removing noise-inducing components, the method 600 ensures that the Rasm is processed in its most essential form, leading to cleaner and more accurate dottization. This adaptability, accuracy, and efficiency of the method 600 make it a definitive solution for dottization of the Arabic Rasm in the field of Arabic script processing.

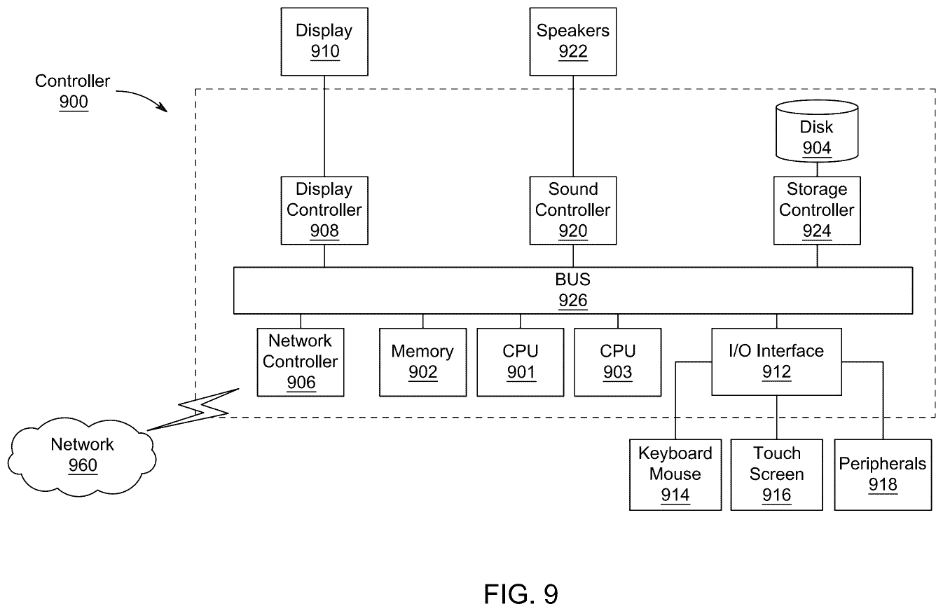

Next, details of the hardware description of the processing circuitry according to exemplary embodiments are described with reference to FIG. 9. In FIG. 9, a controller 900 (as depicted) is representative of the processing circuitry in which the controller 900 is a computing device which includes a CPU 901 and optionally a CPU 903 which performs the processes described above/below. The process data and instructions may be stored in memory 902. These processes and instructions may also be stored on a storage medium disk 904 such as a hard drive (HDD) or portable storage medium or may be stored remotely.

Further, the claims are not limited by the form of the computer-readable media on which the instructions of the inventive process are stored. For example, the instructions may be stored on CDs, DVDs, in FLASH memory, RAM, ROM, PROM, EPROM, EEPROM, hard disk or any other information processing device with which the computing device communicates, such as a server or computer.

Further, the claims may be provided as a utility application, background daemon, or component of an operating system, or combination thereof, executing in conjunction with CPU 901, 903 and an operating system such as Microsoft Windows, UNIX, Solaris, LINUX, Apple MAC-OS, and other systems known to those skilled in the art.

The hardware elements in order to achieve the computing device may be realized by various circuitry elements, known to those skilled in the art. For example, CPU 901 or CPU 903 may be a Xenon or Core processor from Intel of America or an Opteron processor from AMD of America, or may be other processor types that would be recognized by one of ordinary skill in the art. Alternatively, the CPU 901, 903 may be implemented on an FPGA, ASIC, PLD or using discrete logic circuits, as one of ordinary skill in the art would recognize. Further, CPU 901, 903 may be implemented as multiple processors cooperatively working in parallel to perform the instructions of the inventive processes described above.

The computing device in FIG. 9 also includes a network controller 906, such as an Intel Ethernet PRO network interface card from Intel Corporation of America, for interfacing with network 960. As can be appreciated, the network 960 can be a public network, such as the Internet, or a private network such as an LAN or WAN network, or any combination thereof and can also include PSTN or ISDN sub-networks. The network 960 can also be wired, such as an Ethernet network, or can be wireless such as a cellular network including EDGE, 3G and 4G wireless cellular systems. The wireless network can also be WiFi, Bluetooth, or any other wireless form of communication that is known.

The computing device further includes a display controller 908, such as a NVIDIA GeForce GTX or Quadro graphics adaptor from NVIDIA Corporation of America for interfacing with display 910, such as a Hewlett Packard HPL2445w LCD monitor. A general purpose I/O interface 912 interfaces with a keyboard and/or mouse 914 as well as a touch screen panel 916 on or separate from display 910. General purpose I/O interface also connects to a variety of peripherals 918 including printers and scanners, such as an OfficeJet or DeskJet from Hewlett Packard.

A sound controller 920 is also provided in the computing device such as Sound Blaster X-Fi Titanium from Creative, to interface with speakers/microphone 922 thereby providing sounds and/or music.

The general-purpose storage controller 924 connects the storage medium disk 904 with communication bus 926, which may be an ISA, EISA, VESA, PCI, or similar, for interconnecting all of the components of the computing device. A description of the general features and functionality of the display 910, keyboard and/or mouse 914, as well as the display controller 908, storage controller 924, network controller 906, sound controller 920, and general purpose I/O interface 912 is omitted herein for brevity as these features are known.

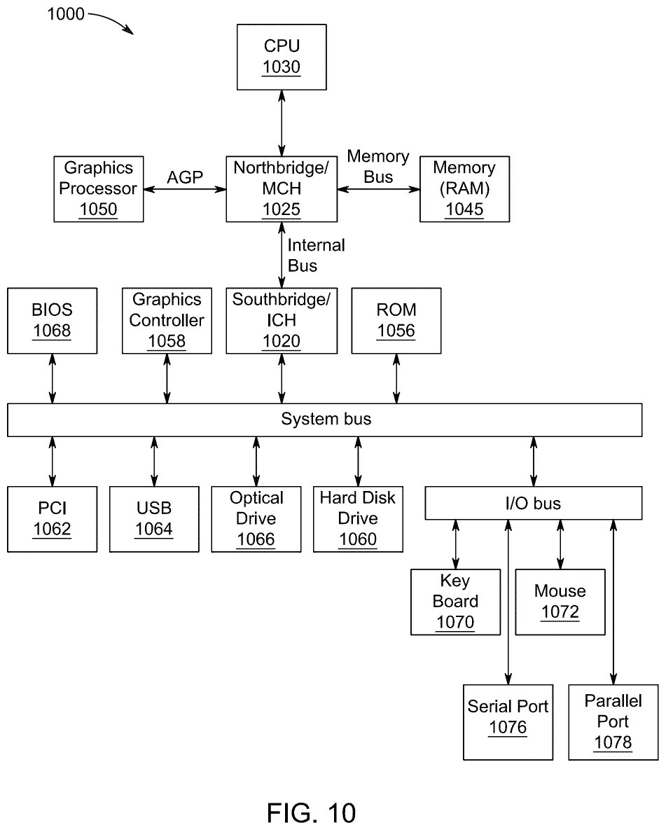

The exemplary circuit elements described in the context of the present disclosure may be replaced with other elements and structured differently than the examples provided herein. Moreover, circuitry configured to perform features described herein may be implemented in multiple circuit units (e.g., chips), or the features may be combined in circuitry on a single chipset, as shown on FIG. 10.

FIG. 10 shows a schematic diagram of a data processing system, according to certain embodiments, for performing the functions of the exemplary embodiments. The data processing system is an example of a computer in which code or instructions implementing the processes of the illustrative embodiments may be located.

In FIG. 10, data processing system 1000 employs a hub architecture including a north bridge and memory controller hub (NB/MCH) 1025 and a south bridge and input/output (I/O) controller hub (SB/ICH) 1020. The central processing unit (CPU) 1030 is connected to NB/MCH 1025. The NB/MCH 1025 also connects to the memory 1045 via a memory bus, and connects to the graphics processor 1050 via an accelerated graphics port (AGP). The NB/MCH 1025 also connects to the SB/ICH 1020 via an internal bus (e.g., a unified media interface or a direct media interface). The CPU Processing unit 1030 may contain one or more processors and may even be implemented using one or more heterogeneous processor systems.

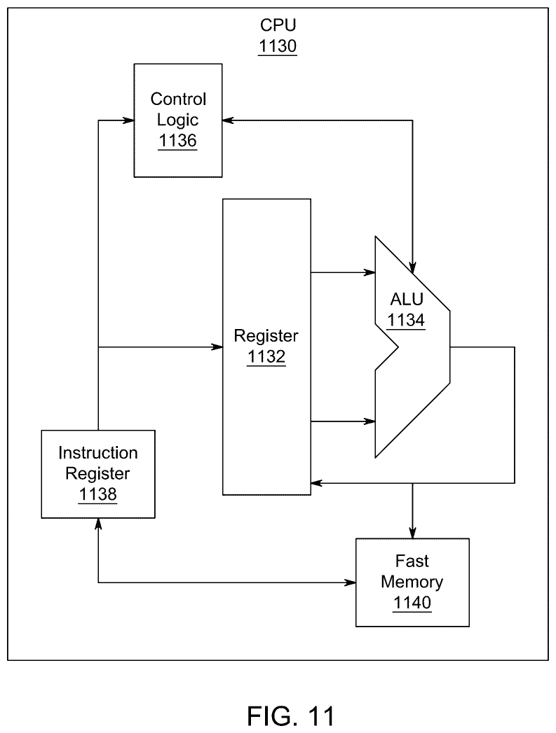

For example, FIG. 11 shows one implementation of CPU 1030. In one implementation, the instruction register 1138 retrieves instructions from the fast memory 1140. At least part of these instructions is fetched from the instruction register 1138 by the control logic 1136 and interpreted according to the instruction set architecture of the CPU 1030. Part of the instructions can also be directed to the register 1132. In one implementation the instructions are decoded according to a hardwired method, and in another implementation the instructions are decoded according to a microprogram that translates instructions into sets of CPU configuration signals that are applied sequentially over multiple clock pulses. After fetching and decoding the instructions, the instructions are executed using the arithmetic logic unit (ALU) 1134 that loads values from the register 1132 and performs logical and mathematical operations on the loaded values according to the instructions. The results from these operations can be feedback into the register and/or stored in the fast memory 1140. According to certain implementations, the instruction set architecture of the CPU 1030 can use a reduced instruction set architecture, a complex instruction set architecture, a vector processor architecture, a very large instruction word architecture. Furthermore, the CPU 1030 can be based on the Von Neuman model or the Harvard model. The CPU 1030 can be a digital signal processor, an FPGA, an ASIC, a PLA, a PLD, or a CPLD. Further, the CPU 1030 can be an x86 processor by Intel or by AMD; an ARM processor, a Power architecture processor by, e.g., IBM; a SPARC architecture processor by Sun Microsystems or by Oracle; or other known CPU architecture.

Referring again to FIG. 10, the data processing system 1000 can include that the SB/ICH 1020 is coupled through a system bus to an I/O Bus, a read only memory (ROM) 1056, universal serial bus (USB) port 1064, a flash binary input/output system (BIOS) 1068, and a graphics controller 1058. PCI/PCIe devices can also be coupled to SB/ICH 1088 through a PCI bus 1062.

The PCI devices may include, for example, Ethernet adapters, add-in cards, and PC cards for notebook computers. The Hard disk drive 1060 and CD-ROM 1066 can use, for example, an integrated drive electronics (IDE) or serial advanced technology attachment (SATA) interface. In one implementation the I/O bus can include a super I/O (SIO) device.

Further, the hard disk drive (HDD) 1060 and optical drive 1066 can also be coupled to the SB/ICH 1020 through a system bus. In one implementation, a keyboard 1070, a mouse 1072, a parallel port 1078, and a serial port 1076 can be connected to the system bus through the I/O bus. Other peripherals and devices that can be connected to the SB/ICH 1020 using a mass storage controller such as SATA or PATA, an Ethernet port, an ISA bus, a LPC bridge, SMBus, a DMA controller, and an Audio Codec.

Moreover, the present disclosure is not limited to the specific circuit elements described herein, nor is the present disclosure limited to the specific sizing and classification of these elements. For example, the skilled artisan will appreciate that the circuitry described herein may be adapted based on changes on battery sizing and chemistry, or based on the requirements of the intended back-up load to be powered.

The above-described hardware description is a non-limiting example of corresponding structure for performing the functionality described herein.

Numerous modifications and variations of the present disclosure are possible in light of the above teachings. It is therefore to be understood that within the scope of the appended claims, the present disclosure may be practiced otherwise than as specifically described herein.

1. A method of dottization of an Arabic Rasm, comprising:
converting the Arabic Rasm to an input sequence comprising machine-readable symbols;
removing one or more components from the input sequence generating a normalized sequence, wherein the one or more components including at least one of a URL, a symbol, a punctuation mark, a white space, a diacritic, and a Kashida character;
consolidating a set of characters appearing in diverse forms in the normalized sequence into a single form of character;
performing a tokenization on the consolidated sequence generating a plurality of tokens;
applying a padding to a first end and to a second end of each token of the plurality of tokens;
inputting the plurality of tokens to a recurrent neural network for processing, wherein the recurrent neural network is trained by mapping between an input and an output of the recurrent neural network;
mapping an output sequence of the recurrent neural network to an Arabic word, wherein the output sequence is the Arabic Rasm with dots; and
mapping the output sequence to the Arabic rasm for generating a training set for the recurrent neural network.

2. The method of claim 1, wherein each token of the plurality of tokens is a word sequence.

3. The method of claim 1, wherein each token of the plurality of tokens is a character sequence of an Arabic script.

4. The method of claim 3, wherein a character in the character sequence comprises a character shape depending on a position of the character in the character sequence.

5. The method of claim 4, wherein the position of the character in the character sequence is at least one a begging of the character sequence, a middle of the character sequence, an end of the character sequence, and an isolated from adjacent characters in the character sequence.

6. The method of claim 1, wherein the recurrent neural network is a bidirectional recurrent neural network.

7. The method of claim 1, wherein the processing by the recurrent neural network further comprises
converting the plurality of tokens to a plurality of dense vectors utilizing an embedding layer, wherein the embedding layer comprising a plurality of dense embeddings;
processing the plurality of dense vectors utilizing a consecutive set of gated recurrent units, the consecutive set of gated recurrent units mapping the input to the output for training the recurrent neural network;
performing a rectified linear unit activation on the processed output utilizing a fully connected dense layer;
reducing overfitting utilizing a dropout layer; and
generating a SoftMax activation function through a dense layer.

8. The method of claim 7, further comprising determining a count of gated recurrent units in the consecutive set of gated recurrent units corresponding to a type of the plurality of tokens.

9. The method of claim 7, further comprising determining a count of units in the dense layer corresponding to a type of the plurality of tokens.

10. The method of claim 1, wherein a type of the plurality of tokens is at least one of a word token and a character token.

11. The method of claim 1, wherein the recurrent neural network employs a sequence-to-sequence learning approach.

12. The method of claim 1, wherein the method further comprises selecting the Arabic Rasm from at least one of an Arabic manuscript, the Arabic Rasm obtained from a text image, and a digital Rasm sequence.

13. A system for dottization of an Arabic Rasm, comprising:
processing circuitry configured to
convert the Arabic Rasm to an input sequence of machine-readable symbols;
remove one or more components from the input sequence to generate a normalized sequence, wherein the one or more components include at least one of a URL, a symbol, a punctuation mark, a white space, a diacritic, and a Kashida character;
consolidate a set of characters appearing in diverse forms in the normalized sequence into a single form of character;
perform a tokenization on the consolidated sequence to generate a plurality of tokens;
apply a padding to a first end and at a second end of each token of the plurality of tokens;
input the plurality of tokens to a recurrent neural network for processing, wherein a training of the recurrent neural network is achieved by mapping an input to an output;
map an output sequence of the recurrent neural network to an Arabic word, wherein the output sequence is the Arabic Rasm with dots; and
map the output sequence to the Arabic rasm as a training set for the recurrent neural network.

14. The system for dottization of an Arabic Rasm of claim 13, wherein the plurality of tokens includes at least one of a word token and a character token.

15. The system for dottization of an Arabic Rasm of claim 14, wherein a character in the character token comprises a character shape depending on a position of the character in the character token.

16. The system for dottization of an Arabic Rasm of claim 13, wherein the recurrent neural network is a bidirectional recurrent neural network.

17. The system for dottization of an Arabic Rasm of claim 13, wherein the processing circuitry is further configured to
convert the plurality of tokens to a plurality of dense vectors utilizing an embedding layer, wherein the embedding layer comprises a plurality of dense embeddings;
process the plurality of dense vectors utilizing a consecutive set of gated recurrent units, wherein the consecutive set of gated recurrent units maps the input to the output for training the recurrent neural network;
perform a rectified linear unit activation on the processed output utilizing a fully connected dense layer;
reduce overfitting utilizing a dropout layer; and
generate a SoftMax activation function through a dense layer.

18. The system for dottization of an Arabic Rasm of claim 17, wherein a count of gated recurrent units in the consecutive set of gated recurrent units is corresponding to a type of the plurality of tokens.

19. The system for dottization of an Arabic Rasm of claim 17, wherein a count of units in the dense layer is corresponding to a type of the plurality of tokens.

20. The system for dottization of an Arabic Rasm of claim 13, wherein the Arabic Rasm is at least one of an Arabic manuscript, the Arabic Rasm obtained from a text image, and a digital Rasm sequence.
